(19) United States
(12) Patent Application Publication
(10) Pub. No.: US 2011/0079076 A1
(43) Pub. Date: Apr. 7, 2011

(54) MOLECULAR MARKERS FOR AUTISM

(76) Inventors: Massimo Castagnola, Roma (IT); Irene Messana, Monserrato (IT); Rosanna Inzitari, Roma (IT); Chiara Fanali, Roma (IT); Tiziana Cabras, Monserrato (IT); Fiorella Gurrieri, Roma (IT); Maria Giulia Torrioli, Roma (IT); Giovanni Neri, Roma (IT)

(21) Appl. No.: 12/996,596

(22) PCT Filed: Jun. 8, 2009
(86) PCT No.: PCT/IB2009/052418

§ 371 Date: Dec. 6, 2010

(30) Foreign Application Priority Data
Jun. 6, 2008 (IT) RM2008A00294

(51) Int. Cl. G01N 30/62

(52) U.S. Cl. 73/61.55

(57) ABSTRACT

The invention relates to the determination of phosphorylation levels of some specific salivary peptides (statherin, histatin 1, acidic proline-rich proteins, both in whole form (PRP-1 type) and in truncated form (PRP-3 type) as a non-invasive diagnostic marker with a >40% sensitivity for defining autism spectrum disorders (ASDs) patients, methods for performing said determination, a kit for the non-invasive diagnosis of at least 40% of autism cases, containing means for such a determination, and the use of such a determination for therapeutical research on autism.

The invention relates to the determination of phosphorylation levels of some specific salivary peptides (statherin, histatin 1, acidic proline-rich proteins, both in whole form (PRP-1 type) and in truncated form (PRP-3 type) as a non-invasive diagnostic marker with a >40% sensitivity for defining autism spectrum disorders (ASDs) patients, methods for performing said determination, a kit for the non-invasive diagnosis of at least 40% of autism cases, containing means for such a determination, and the use of such a determination for therapeutical research on autism.

### STATE OF THE PRIOR ART

Autism spectrum disorders (ASDs) are a group of syndromes which generate a neurological development impairment characterized by altered emotional, social and communicative skills and by stereotyped mental and motor activities with an onset of the disease within three years from birth. Children with ASDs have difficulties at interacting with the environment, and about 50% of them are affected by mental retardation. ASDs are the most common neuro-developmental disorders (0.6%) of complex and unknown etiology [4]. Genetic factors seem to play a fundamental role; chromosomal abnormalities are found in about 10% of patients, or mutations in single genes involved in synaptic development (in approximately less than 5% of patients). However, a generally shared opinion is that autism susceptibility be caused by a small number of genes exerting a determinant action and a greater number of genes with a “weak” action acting in concert. Given such multiple genes involvement and the phenotypic complexity of the disorder, a research method apt to identify biological causes of ASDs has always been sought.

Another problem with ASDs is that the diagnosis of the disorder is currently based only on neurologic medical data; hence, intervention of a neurologist or a neurological team is required in order to diagnose ASDs, according to a set of parameters set a priori, on the basis of the medical symptomatology observed, parameters that subsequently have to be interpreted by the physician. Not less important is the fact that, due to their communication problems, ASD patients hardly collaborate with the neurologist, making diagnosis of the disease even more difficult.

Therefore, the absence of biological markers for ASDs allows neither an easy diagnosis, nor the research and development of drugs for the treatment and/or prevention of the disorder or of some of its forms.

The literature (4) clearly indicates that currently there are no biological markers allowing to identify ASDs cases, and that there are no biological markers allowing to discriminate among distinct classes of autism spectrum disorders (major ones subdivide into patients affected by mental retardation and patients not affected by mental retardation)

ASDs markers allowing to diagnose a high number of cases of the disease, optionally allowing to recognize different subtypes and focus pharmacological research, are strongly required and would be of obvious and indubitable usefulness for the scientific world, the physicians and the patients.

### SUMMARY OF THE INVENTION

The authors of the present invention hypothesized that recent developments in proteomic studies might be used to single out ASDs markers.

Saliva is until now neglected as a body fluid for diagnostic purposes, mainly due to its high polymorphism [1]. However, it contains a set of specific peptides (which are found only in the oral cavity) such as histatins, statherin and proline-rich proteins that undergo, during the secretory process, an articulated maturation process involving a complex set of enzymes such as glycosidase, kinase, sulfatase and protease, operating in the Golgi apparatus of acinar cells of the major (parotid, submandibular, sublingual) and minor secretory salivary glands [1,2]. Recent studies indicate how several of these enzymes are present in many other organs and tissues exhibiting exocrine and endocrine secretory process similar to the salivary ones [1,2]. To date, studies on the intact integrated protein complex of whole saliva enabled to identify more than 120 salivary components that, besides comprising proteins and peptides of the mentioned classes, include many of their derivatives, such as partially phosphorylated isoforms, sulfated isoforms, truncated isoforms [1,2]. Therefore, determination of the ratio between these derivatives and the main isoform can then be used as a measure of the activity of the enzyme involved in peptide maturation. In particular, determination of isoform ratios at various phosphorylation stages can be used to characterize the activity of the kinase involved in the maturation-secretion process. This serin-kinase, of unknown structure and sequence, is detected in various tissues on the basis of the specific recognition sequence (Ser-X-(Glu/Ser(phos)) that the kinase recognises on the peptide to be phosphorylated [1,2]. By virtue of this feature, activity of this kinase has been revealed, other than in salivary glands, in organs such as mammary glands, kidney, spleen, liver and central nervous system [1]. By means of a study on the saliva of pre-term newborns, it has been determined that the activity of this kinase follows a maturation pathway with a precise timetable, reaching the stages observed in adults at an age of about 8-10 months from birth [3]. Therefore, determination of the ratios between different salivary components may be used in integrated studies for identifying potential molecular causes of multi-factorial diseases of unknown etiology.

In this context, the authors of the present invention evaluated the existence of altered phosphorylation states in patients affected by autism spectrum disorders.

HPLC-ESI-MS analysis of naturally occurring peptides (peptidome) of whole human saliva has led to the detection of more than 120 salivary components (2). The statistical analysis carried out surprisingly revealed statistical differences between ASDs patients and controls for the phosphorylation levels of statherin, histatin 1 and acidic PRPs.

It has been hence surprisingly discovered that the phosphorylation state of at least one of the proteins comprised in the group statherin, histatin and salivary PRP-1 and PRP-3 isoforms, is correlated with ASDs.

The hypo-phosphorylation level, versus the standard for each salivary peptide herein indicated, proved to be a necessary and sufficient marker of autism.

Therefore, the present invention relates to the determination of the phosphorylation state of at least one of the aforementioned proteins, for the diagnosis of at least 40% of the ASDs forms.

Therefore, the present invention provides a method for the determination of the phosphorylation of statherin, histatin, and PRP-1 and PRP-3 salivary isoforms comprising the following steps:

a patient's salivary sample is collected;

said sample is subjected to examination for identification and quantification of the phosphorylation levels of at least one of the proteins selected from the group comprising statherin, histatin, PRP-1 and PRP-3;

the phosphorylation data thus obtained are compared to normal standard values; a divergence of these values in the form of hypo-phosphorylation indicates presence of ASDs.

The invention also relates to diagnostic kits for the diagnosis of at least 40% of ASDs cases, comprising reagents necessary to the evaluation of phosphorylation from salivary samples of at least one of the proteins selected from the group comprising statherin, histatin, PRP-1 and PRP-3.

### DETAILED DESCRIPTION OF THE FIGURES

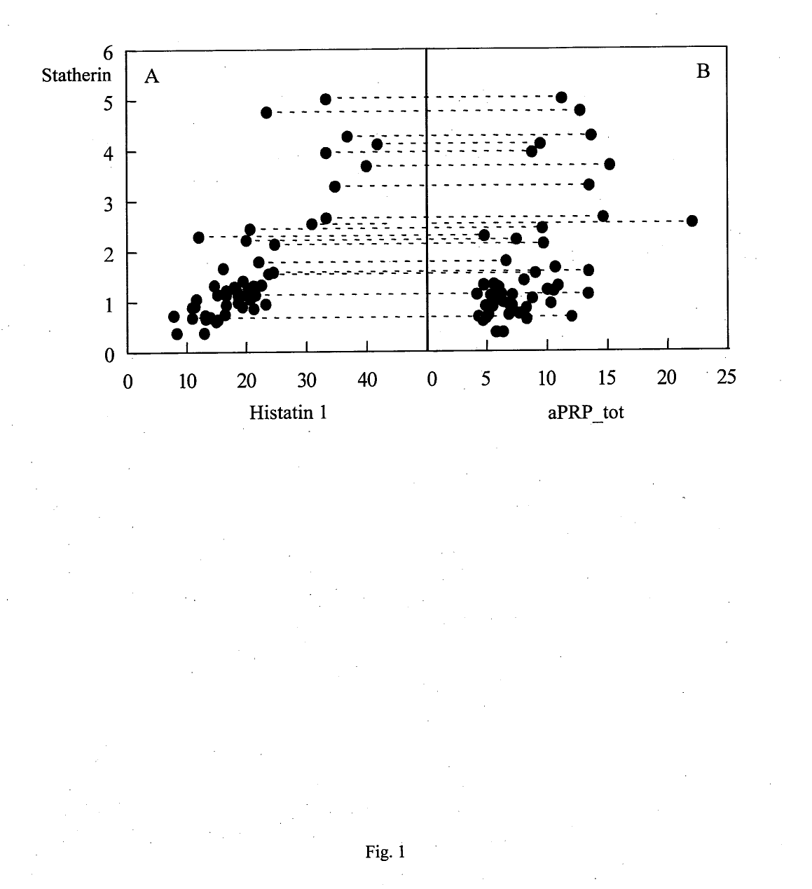

FIG. 1:

The figure illustrates the phosphorylation levels measured with the ratios described in the preceding section on statherin, histatin 1 and total acidic PRPs. Graph A correlates the values measured on statherin and histatin 1 (on the same subject), whereas Graph B correlates statherin and acidic PRPs total values. Black circles (blue in a colour printing) refer to normal subjects. Grey circles (red in a colour printing) refer to autism spectrum disorder patients.

Dashed lines connect the 18 subjects (out of 27) that showed at least one hypo-phosphorylated peptide and that therefore can be included in the “hypo-phosphorylated” group of patients. Seven patients exhibit hypo-phosphorylation levels on all three parameters.

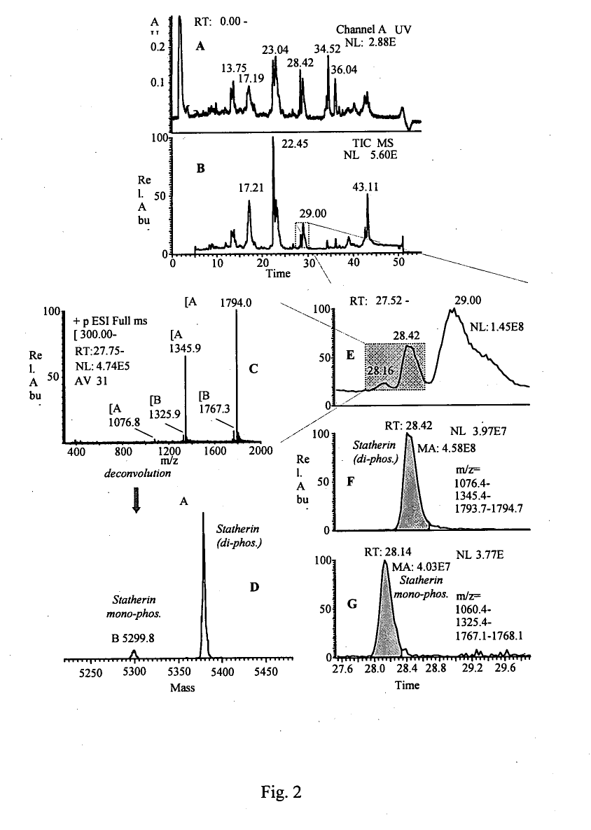

FIG. 2

FIG. 2 shows an example of research of statherin phosphorylation levels. The figure shows a RP-HPLC-ESI-MS graph of the acidic soluble fraction of a whole saliva sample from an ASD subject and the procedure carried out for the measurement of statherin phosphorylation levels. Graphs A and B: chromatographic runs, revealed by spectrometer at 214 nm (A) and by means of the total ion current (TIC) from mass spectrometer (B). Graph C: ESI spectrum recorded in the 27.75-28.60 min elution range (average of 31 MS acquisitions). ESI spectrum deconvolution is reported in graph D, where the average masses of statherin (5379.7 Da, di-phosphorylated) and mono-phosphorylated statherin (5299.8 Da) are provided. Graph E reports an enlargement of the TIC profile in the 27.52-29.91 min elution range. Graphs F and G show the peaks obtained by XIC (eXtracted ion current) researches, with the area, measured by integration, for statherin (F) and mono-phosphorylated statherin. RT: retention time; NL: normalization level; AV: average; MA: measured area.

### DETAILED DESCRIPTION OF THE INVENTION

The method of the invention is based on the determination of the ratios existing between mono-phosphorylated statherin and (di-phosphorylated) statherin, and/or between histatin 2 (non-phosphorylated histatin 1) and (mono-phosphorylated) histatin 1, and/or between the mono-phosphorylated PRP-1 type salivary isoforms and the di-phosphorylated ones, and/or between the mono-phosphorylated PRP-3 type salivary isoforms and the di-phosphorylated ones. Alternatively, the two parameters PRP-1 and PRP-3 may be measured as sum of PRP-1 and PRP-3.

Statherin is a salivary-specific peptide of 43 amino acids residues, di-phosphorylated on Ser-2 and Ser-3. It elutes at about 28.1-28.5 min under the HPLC-ESI-MS conditions described in the examples. A mono-phosphorylated statherin derivative is always detectable in whole saliva and its chromatographic elution always slightly anticipates that of one of the statherin peaks (Table 1, FIG. 2). The principal features of the RP-HPLC-ESI-MS analysis are reported in FIG. 2 and the phosphorylation level of Statherin was established on the basis of the following ratio of the XIC peak area:

Histatin 1 is a histidine-rich peptide of 30 [38] amino acid residues mono-phosphorylated on Ser-2 and specific of human saliva. Histatin 2, always detectable in whole saliva is the non-phosphorylated form of histatin 1. These two histatins closely elute (Table 1).

All aPRPs isoforms are described in the literature, however it is worthwhile to mention that the PRP-1, PRP-2 and PIF-s isoforms differ for D-N substitutions and the very similar average masses (di-phosphorylated: 15514-15515 Da) did not allow their discrimination by HPLC-ESI-MS experiments. Therefore, in the present invention they have been collectively termed PRP-1 type isoforms. The same is true for the truncated PRP-3, PRP-4 and PIF-f forms (di-phosphorylated: 11162-11163 Da), here collectively termed PRP-3 isoforms.

According to the present invention, a deviation from normal phosphorylation values in the form of hypo-phosphorylation of at least one of the above-indicated proteins indicates ASDs syndrome.

Advantageously, a measurement of the phosphorylation of all of the proteins indicated herein allows to broaden the diagnosis, getting to identify at least 50% of the ASDs cases under study.

Therefore, to the ends of the present invention, the diagnostic method could be carried out by measuring the phosphorylation levels of one or more of the indicated proteins; accordingly, the diagnostic kit of the invention could comprise one or more aliquots of each reagent required for measurement of the phosphorylation of at least one of the above-indicated proteins. Evidently, the kit of the invention could comprise the reagents (divided into one or more aliquots, in ready-to-use solutions or mother solutions, in a form to be resuspended or in a form already suspended) for the measurement of the phosphorylation levels of all proteins indicated.

The kit will comprise an implementation protocol and an index of normal values beyond which ADSs are diagnosed.

The sample on which such a determination is performed is a salivary sample.

Therefore, the method is particularly advantageous as absolutely non-invasive.

The determination of the phosphorylation ratios between the various forms of the above-indicated proteins may be performed by any phosphorylation measurement technique known to a person skilled in the art. For instance, a reversed phase high-performance chromatography may be used, coupled to a mass spectrometer with electrospray ionization/ion trap mass spectrometer.

The whole saliva sample is collected with a soft plastic pipette, usually under the tongue. Other collection types are possible (tampons, collections by dripping). Sample is mixed immediately after collection, in a 1:1 v/v ratio with an aqueous solution of 0.2% (v/v) 2,2,2-trifluoroacetic acid (TFA). Analogous ratios or treatment solutions may be used, such as formic acid solutions and aqueo-organic mixtures.

Post-centrifugation (>3000 rpm) precipitate (containing mainly mucins) is removed and the acidic solution can be immediately analysed in the apparatus. The chromatographic column may be a reversed-phase column (C4, C8, C18 or the like) and the eluents may be of various type. Described results were obtained with a Vydac C8 column, with 5 μm particles, length =15 cm, ø=2.1 mm. The eluents utilized are: A: 0.56% [0.056%] (v/v) aqueous solution and B: water/acetonitrile 20/80 (v/v) solution. Various gradients are applicable. The gradient usually applied is linear, from 0%B to 55%B in 40 min. The flow rate commonly utilized is of 0.3 mL/min. Outlet eluent may be completely injected into the spectrometer, or sent partly to a continuously reading spectrophotometer and partly to the mass spectrometer.

The chromatogram acquired by mass spectrometer is processed with computer techniques intrinsic to the program managing the apparatus, in particular with ion current extraction (XIC) techniques on m/z values belonging to peptides or proteins of interest. An example of possible values for the search are reported in Table 1.

TABLE 1
m/z values used for the XIC searches of
salivary peptides relevant to the description

| | | M aver Da | Elution | m/z values (± 0.5) | | |
|---|---|---|---|---|---|---|
| | | (theor) | time | selected for the | | |
| Peptide o | | experim. | (min) | XIC searches | | |
| Statherin | mono-phos. | (5299.7) | 27.9-28.3 | 1060.9 | 1325.9 | 1767.6 |
| | | 5299.9 ± 0.5 | | | | |
| Statherin | (di-phos.) | (5379.7) | 28.1-28.5 | 1076.9 | 1345.9 | 1794.2 |
| | | 5379.9 ± 0.5 | | | | |
| Histatin 2 | (non-phos.) | (4848.2) | 23.0-23.3 | 1213.5 | 1617.4 | |
| | | 4848.2 ± 0.5 | | | | |
| Histatin 1 | (mono-phos.) | (4928.2) | 23.0-23.3 | 1233.5 | 1644.1 | |
| | | 4928.2 ± 0.5 | | | | |
| PRP-1 isof. | mono-phos. | (15434-15435) | 23.2-23.6 | 1287.3 | 1404.2 | 1544.5 |
| | | 15435 ± 2 | | | | |
| PRP-1 isof. | (di-phos.) | (15514-15515) | 22.4-22.8 | 1293.9 | 1411.5 | 1552.5 |
| | | 15515 ± 2 | | | | |
| PRP-1 isof. | tri-phos. | (15594-15595) | 22.0-22.4 | 1300.6 | 1418.7 | 1560.5 |
| | | 15595 ± 2 | | | | |
| PRP-1 isof. | mono-phos. | 15558 ± 3 | 23.2-23.6 | 1296.7 | 1414.5 | 1555.8 |
| (TFA adduct) | | | | | | |
| PRP-1 isof. | (di-phos.) | 15628 ± 3 | 22.4-22.8 | 1303.3 | 1421.7 | 1563.8 |
| (TFA adduct) | | | | | | |
| PRP-1 isof. | tri-phos. | 15708 ± 3 | 22.0-22.4 | 1310.3 | 1429.0 | 1571.8 |
| (TFA adduct) | | | | | | |
| PRP-3 isof. | mono-phos. | (11081-11082) | 23.5-24.0 | 1109.2 | 1232.3 | 1584.2 |
| | | 11082 ± 1 | | | | |
| PRP-3 isof. | (di-phos.) | (11161-11162) | 22.8-23.3 | 1117.2 | 1241.2 | 1595.6 |
| | | 11162 ± 1 | | | | |
| PRP-3 isof | tri-phos. | (11241-11242) | 22.3-22.8 | 1125.2 | 1250.0 | 1607.1 |
| | | 11242 ± 2 | | | | |

Triphosphorylated PRP-1 and PRP-3 forms are often not detectable in the chromatogram.

The area of the peaks obtained in XIC searches is integrated and the following ratios are computed:

For statherin

Ratio=100×statherin mono-phos./(statherin mono-phos.+2×statherin di-phos.)

For histatin 1

Ratio=100×histatin 2/(histatin 2+histatin 1)

For PRP-1

Ratio=100×PRP-1 mono-phos./(PRP-1 mono-phos.+2×PRP-1 di-phos.+3×PRP-1 tri-phos.)

(TFA adducts included)

For PRP-3 isoforms

Ratio=100×PRP-3 mono-phos./(PRP-3 mono-phos.+2×PRP-3 di-phos.+3×PRP-3 tri-phos.)

These two latter ratios may be replaced by a ratio considering the sum of the areas of the PRP-1 and PRP-3 isoforms

Ratio=100×aPRP(tot) mono-phos./(aPRP(tot) mono-phos.+2×aPRP(tot) di-phos.+3×aPRP(tot) tri-phos.)

(aPRP(tot) include PRP-1 isoforms, plus TFA adducts, plus PRP-3 isoforms)

Other ratio typologies evident to a person skilled in the art lead to equivalent results.

The phosphorylation levels, computed by this method, allow to discriminate an ASDs patient, including him/her in the “hypo-phosphorylation group”.

The mean values of normal (n=23) and autistic (n=27) subjects (equal age) are reported in Table 2

TABLE 2
Means of the phosphorylation levels (non-
phosphorylated/phosphorylated ratio) of normal subjects
and ASDs patients. Therefore, higher values indicate
hypo-phosphorylation.

| Subjects | Age (y) | Statherin | Histatin | aPRP (tot) | PRP-1 | PRP-3 |
|---|---|---|---|---|---|---|
| Autistic group | r1.5-8.5^{a} | m 2.23 | m 23.87 | m 9.93 | m 9.06 | m 11.69 |
| (N = 27) | m 4.65 | sd 1.31 | sd 8.83 | sd 4.05 | sd 3.83 | sd 4.58 |
| Controls | r1.5-9.0 | m 0.95 | m 16.67 | m 6.85 | m 6.40 | m 7.74 |
| (N = 23) | m 5.00 | sd 0.32 | sd 4.18 | sd 2.10 | sd 1.95 | sd 2.86 |
| P (student's | n.s. (>0.4) | <0.00001 | <0.0005 | <0.005 | <0.005 | <0.005 |
| t-test) | | | | | | |

As may be deduced from the Table, normal values for statherin on average are below about 2, for histatin below about 20-22, for total aPRP below about 10-11, for PRP-1 below about 8-9 and for PRP-3 below about 10-12.

Therefore, according to the present invention, differences between the phosphorylation ratio of the proteins under study can be observed which are statistically significant between the healthy and autistic groups, having the ASDs group a relative abundance of hypo-phosphorylated derivatives higher than the control group.

Moreover, the present invention reveals that there is a significant correlation computed among the levels of the three salivary peptides (Table 3). The correlation is significant both when considering the two groups separately and when considering globally all subjects under study. The present invention teaches that the autistic group can be divided, following a protein phosphorylation analysis of the invention, in two sub-groups, a group having at least one value outside the normal phosphorylation range, and a group in which phosphorylation values are similar to those of the healthy group for all three peptides.

It was surprisingly found that all of the autistic subjects who had no mental retardation were comprised in the hypo-phosphorylated group. Therefore, the present invention can be utilized to identify over 80%, and preferably over 90% of autism cases in which no mental retardation is present.

The method for identifying such forms of autism is identical to the preceding one.

Accordingly, the kit of the invention could be a kit for the diagnosis of at least 80%, preferably at least 90% of ASDs case in which no mental retardation is present or cognitive development is deemed border-line.

The following example indicates a possible way for carrying out the invention, jointly to possible reagents present in the kit of the invention. Evidently, in the cases in which different methodologies known to a person skilled in the art are utilized in order to evaluate phosphorylation levels, the kit will comprise suitable reagents.

Therefore, the following examples are not meant to limit the present description.

The method of the present invention could be carried out by utilizing also healthy controls in order to normalize obtained data, and the kit of the invention could comprise suitable control salivary extracts.

### EXAMPLES

### Example 1

### Subjects Under Study and Sample Collection

The subjects analyzed were 27 children (7 females and 20 males) with a diagnosis of: autism spectrum, Asperger's syndrome, pervasive developmental disorder not otherwise specified (PDD-NOS) according to DSMS IV criteria. All subjects analyzed were evaluated by the same team of neuropsychiatrists in order to obtain uniform evaluation. The diagnostic procedure included two interviews with parents and three play sessions with the children, with and without parents, to evaluate the communication and relational skills with parents and physician. Stereotyped behaviours were also observed. 12 subjects had a diagnosis of autism, 1 subject had a diagnosis of Asperger and 14 subjects of PDD-NOS. On 14 children it was possible to carry out a developmental evaluation (Griffith or WISC-R), while for the others the evaluation was impossible due to difficulty to evaluate whether lack of collaboration was due to lack of collaboration [relational impairment] or to mental retardation. Of these 14 subjects, 10 were found to have a normal-borderline cognitive development, while 4 were found to have mental retardation. The age of subjects ranged between 1.5 and 9 years, except for one subject who was 15 years old. The control group comprised 23 healthy children with an age between 1.5 and 8.5 years. The age of the two groups was not statistically different (p>0.4). Informed consent for specimen collection was obtained from the parents of all children.

### Example 2

### Materials and Apparatus

All general chemicals and reagents were of analytical grade and were purchased from Farmitalia-Carlo Erba (Milano, Italy), Merck (Damstadt, Germany), Sigma Aldrich (St. Louis, Mich., USA). The HPLC-ESI-MS was a ThermoFinnigan (San Jose, Calif., USA) apparatus. The Surveyor HPLC system was equipped with a PDA (Photodiode Array) detector and connected by a T splitter to the electrospray ionization/ion trap mass spectrometer LCQ Deca XP Plus (ThermoFinnigan). The chromatographic column was a Vydac (Hesperia, Calif., USA) C8 with 5 μm particle diameter (column dimensions 150×2.1 mm).

### Example 3

### Sample Collection

Whole human saliva was collected according to a standard protocol. The collection was performed around 11-13 AM, and anyhow at least 30 min after any food or beverage admission and tooth brushing. Whole saliva was collected with a small plastic aspirator at the basis of the tongue for less than 1 min and transferred to a plastic tube. An acidic solution (0.2% TFA, 2,2,2-trifluoroacetic acid) in ice was immediately added in a 1:1 v/v ratio and the solution centrifuged at 8000 g at 4° C. for 5 min. After precipitate removal (mainly mucins) the acidic solution was either immediately analysed by HPLC-ESI-IT-MS or stored at −80° C.

### Example 4

### HPLC-ESI-IT-MS

Separation and detection of salivary proteins and naturally occurring peptides was performed using RP-HPLC-ESI mass spectrometry. The following solutions were utilized for the reversed-phase chromatography: (eluent A) 0.056% (v/v) aqueous TFA and (eluent B) 0.05% (v/v) TFA in water-acetonitrile 20/80. The proteins were eluted using a linear gradient from 0 to 55% of B in 40 min, at a flow rate of 0.30 mL/min. A T splitter addressed a flow rate of 0.20 mL/min towards the diode array detector and a flow rate of 0.10 mL/min towards the ESI source. Usually, during the first five minutes of RP-HPLC separation the eluate was not addressed towards the ion trap MS apparatus in order to avoid instrument damage deriving from the high salt content. Mass spectra, in the positive ion mode, were collected every 3 milliseconds. MS spray voltage was 4.50 KV and the capillary temperature was 220° C. By this method more than 120 proteins (cystatins, aPRPs, bPRPs, histatins, statherin and P-B peptide) and naturally occurring peptides deriving from aPRPs, bPRPs, histatins, statherin and P-B peptide were identified in previous studies, as previously indicated.

### Example 5

### Data Collection

Deconvolution of averaged ESI-MS spectra was automatically performed either by using the Bioworks Browser software provided with the Deca XP instrument or by MagTran 1.0 software. XIC strategy was employed to selectively reveal salivary peptides of the present invention. The m/z values used in the multiple XIC strategy were carefully selected in order to exclude values common to other closely eluting proteins (±0.5 m/z; see Table 1). The area of the XIC peaks, considered when the S/N ratio was at least 5, was used for estimation of relative peptide/protein amounts.

1. A method of using statherin and/or of histatin and/or of PRP-1 and PRP-3 salivary isoforms for the diagnosis of at least 40% of ASDs forms.

2. A diagnostic method for at least 40% of ADSs forms for the determination of the phosphorylation of statherin, histatin and PRP-1 and PRP-3 salivary isoforms comprising the following steps:
a patient's salivary sample is collected;
said sample is subjected to examination for identification and quantification of the phosphorylation levels of at least one of the proteins selected from the group comprising statherin, histatin, PRP-1 and PRP-3;
phosphorylation data obtained from said samples are compared to normal standard values; a divergence of these values in the form of hypo-phosphorylation indicates presence of ASDs.

3. A diagnostic method for at least 80% of ASDs forms not correlated to mental retardation or with border-line cognitive skills for the determination of the phosphorylation of statherin, histatin and PRP-1 and PRP-3 salivary isoforms comprising the following steps:
a patient's salivary sample is collected;
said sample is subjected to examination for identification and quantification of the phosphorylation levels of at least one of the proteins selected from the group comprising statherin, histatin, PRP-1 and PRP-3;
phosphorylation data obtained from said samples are compared to normal standard values; a divergence of these values in the form of hypo-phosphorylation indicates presence of ASDs not correlated to mental retardation or with border-line cognitive skills.

4. A diagnostic kit for at least 40% of ASDs cases comprising aliquots of the reagents necessary to the evaluation of phosphorylation from salivary samples of at least one of the proteins selected from the group comprising statherin, histatin, PRP-1 and PRP-3 and, optionally, salivary control samples.

5. A diagnostic kit for at least 80% of ASDs cases not associated to mental retardation or with presence of border-line cognitive development, comprising aliquots of the reagents necessary to the evaluation of phosphorylation from salivary samples of at least one of the proteins selected from the group comprising statherin, histatin, PRP-1 and PRP-3 and, optionally, salivary control samples.
